(19) United States
(12) Patent Application Publication
(10) Pub. No.: US 2006/0281052 A1
(43) Pub. Date: Dec. 14, 2006

(54) Method and simulator device for training a pilot of a vessel

(75) Inventors: Geir Arne Almas, Kvernaland (NO); Kjell Egil Helgay, Bru (NO)

Correspondence Address: BOHAN, MATHERS & ASSOCIATES, LLC, PO BOX 17707, PORTLAND, ME, 04112-8707, US

(73) Assignee: Teekay Norway AS, Stavanger (NO)

(21) Appl. No.: 10/558,349

(22) PCT Filed: Apr. 23, 2004
(86) PCT No.: PCT/NO04/00111

§ 371 Date: Nov. 23, 2005

(30) Foreign Application Priority Data
May 26, 2003 (NO) 20032347

(51) Int. Cl. G09B 9/02

(52) U.S. Cl. 434/29

(57) ABSTRACT

A method and a simulator device for training a pilot of a vessel (6) in the use of so-called dynamic positioning, called DP, wherein a first distance signal representing a distance between the vessel (6) and a loading buoy or other target (1), is optionally fed directly to a control system (13) for normal DP operation, or wherein the first distance signal is directed by way of a transducer (22) feeding a second distance signal to the control system (13) for simulation. The second distance signal represents another and normally shorter distance than the first distance signal.

The invention relates to a method and a simulator device, more particularly a simulator for training a pilot of a vessel in the use of so-called dynamic positioning.

Dynamic positioning, in the following called DP, of a ship or other vessel involves monitoring the position of the vessel within a reference system and activating the propulsion machinery and control mechanisms of the vessel, so that the vessel is kept in a desired position. Particular systems have been developed for DP and such systems are common in vessels used in connection with oil activities offshore.

A reference system for determining positions may include transmitters placed on the sea floor, on buoys, vessels or on shore, and it may include transmitters in satellites orbiting the earth.

DP is used extensively in connection with tankers, which are being connected to a loading buoy or another vessel on the open sea for the transfer of oil. Such operations take place with a relatively short distance between the vessel and loading buoy or between two vessels, and require special knowledge and experience of the pilot of the vessel.

It is known to train vessel pilots and trainees by means of a simulator, for example it is known to practice to master the approach to and departure from port facilities. Training on a simulator is also known from other fields, such as the piloting of aircraft.

It would be obvious to build simulator facilities, in which a vessel pilot or a trainee could practice manoeuvring and keeping a large tanker by a loading buoy or by another vessel by means of DP. Great benefit from such training is dependent on the vessel pilot's experiencing the simulator as realistic. In practice this requires that the simulator includes an area which is equipped as a bridge, and in which the vessel pilot can experience realistic vessel motion. However, such simulators are extremely expensive to build and operate. Besides, they require that the vessel pilot leaves the vessel to practice.

The object of the invention is to provide a method and a simulator device for use onboard a vessel which is equipped for dynamic positioning, and in which the vessel pilot or a trainee can practice using dynamic positioning.

The object is realized through the features specified in the following description and subsequent claims.

A simulator according to the invention uses the vessel itself and the DP equipment already available on board. Based on the invention, the DP equipment may be divided into two main blocks, a measuring system and a control system.

The measuring system acquires measured data and calculates the position of the vessel within a reference system and feeds a distance signal indicating the distance between the vessel and a target, such as a loading buoy or another vessel, to the control system. The position of the target is known to the measuring system. This is true even if the target is moving.

According to the invention, the distance signal is changed before it is transmitted to the control system and in such a way that the distance signal represents another distance, typically a smaller distance, than the distance calculated by the measuring system.

Thereby the DP system can be brought to display screen images and data as if the vessel was close to the target, even if there is a great distance between the vessel and the target. The vessel pilot may then position and orient the vessel and adjust the parameters of the DP system and immediately see the effect on the screen images of the DP system. By positioning the vessel a thousand metres from the target and changing the mentioned distance signal in such a way that it represents a hundred metres, the vessel pilot may practice as if the distance was just a hundred metres. The screen images of the DP system will show that the vessel is near the target; warnings, alarms and other user data from the DP system will work as if the distance was just a hundred metres.

Thereby is achieved that the vessel pilots may train in realistic surroundings, in realistic weather conditions and with exactly the same equipment that the vessel pilot will have at his disposal in a real situation. Training may take place, for example, while the vessel is already waiting for a place to become vacant at the loading buoy.

The invention is be described in further detail below by means of an exemplary embodiment, and reference is made to the appended drawings, in which:

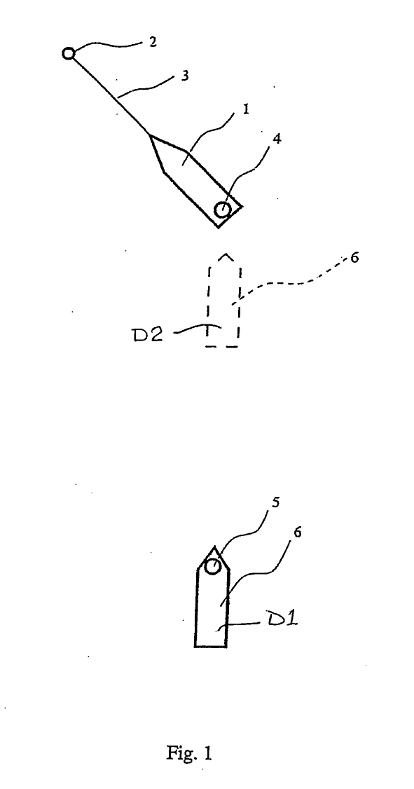

FIG. 1 shows an anchored buffer vessel and a tanker at a distance from the buffer vessel;

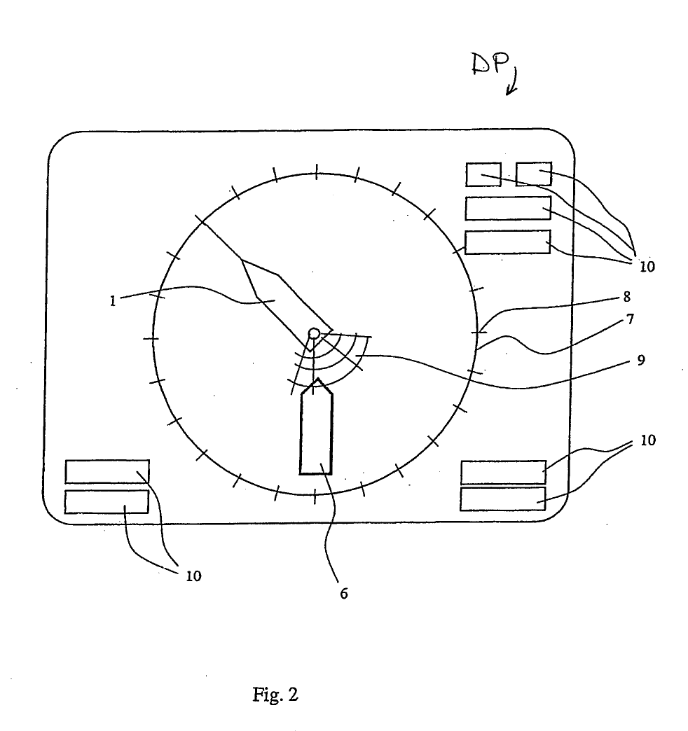

FIG. 2 shows a simplified screen image;

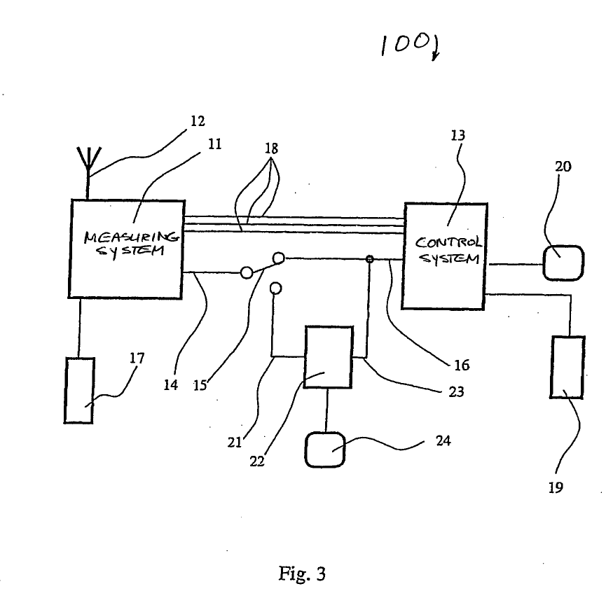

FIG. 3 shows a simplified block diagram of a dynamic positioning system with optional additional processing of the distance signal.

In FIG. 1 the reference numeral 1 identifies a buffer vessel anchored to an anchor point 2 by an anchor line 3. The position of the buffer vessel 1 relative to the anchor point 2 varies with the wind and current conditions. A probe 4 emits signals that can be picked up by a receiver 5 on a tanker 6 equipped with a DP system. The tanker 6 temporarily connects to the buffer vessel 1 for oil to be transferred through a hose system, which is not shown. While oil is being transferred, the tanker 6 is positioned relatively close to the buffer vessel 1, as is shown in dotted line in FIG. 1.

The DP system on the tanker 6 is arranged to be operated by an operator panel including at least one display screen, in which the DP system can display the position of the tanker 6 relative to the buffer vessel 1 much the same as shown in FIG. 2. Within a circular area 7 of bearing lines 8 are shown the buffer vessel 1 and the tanker 6 and part of a graduated network 9 referring to the buffer vessel 1, on which the vessel pilot can read the relative bearing and distance between the vessels 1, 6.

Information boxes 10 provide information corresponding to that of the graduated network 9 and further information on wind, currents, motor admission and other information that the vessel pilot will need.

The DP system is shown schematically in FIG. 3, in which a measuring system 11 includes a receiver, not shown, which is arranged to an antenna 12 arranged to receive signals from a probe 4 on the buffer vessel 1 (see FIG. 1) and calculate the distance of the tanker 6 from the buffer vessel 1 and generate a distance signal which is transmitted to a control system 13 through a first connection 14, a change-over switch 15 and a second connection 16.

The measuring system 11 is further connected to sensors 17 on the tanker 6 and arranged to calculate and transmit measurement signals for compass direction, speed, motor admission and other information to the control system 13 through connectors 18. The control system 13 is connected to actuators 19 to provide admission for the propulsion machinery and control mechanisms of the tanker 6. The control system 13 is further arranged with an operator panel 20.

The change-over switch 15 is arranged to optionally connect the distance signal output by the measuring system 11 on the first connection 14 to the second connection 16 connected to an input in the control system 13, or to connect the distance signal from the measuring system 11 to a third connection 21 connected to an input in a transducer 22.

The transducer 22 is arranged to receive a first distance signal, convert it into a second distance signal, which can represent a distance value different from the first distance signal. The transducer 22 outputs a second distance signal on a fourth connection 23 connected to the second connection 16, as is shown in FIG. 3. The transducer 22 is arranged with an operator panel 24, on which the signal conversion can be set.

By setting the change-over switch 15 in such a way that the first distance signal from the measuring system 11 is directed to the transducer 22, and additionally setting the transducer 22 to generate a second output distance signal representing a smaller distance than the first distance signal, the operator panel 20 of the DP system will show that the tanker 6 is close to the buffer vessel 1, as shown in FIG. 2, even if the distance between the vessels 1, 6 is substantially greater.

Referring to FIG. 1, the operator panel of the DP system could display a situation corresponding to the tanker 6 being in a position shown in dotted line, instead of the true position in which the tanker 6 is shown in a solid line. The pilot of the tanker 6, or a trainee, may then at a safe distance practice manoeuvring the tanker 6 relative to the buffer vessel by means of the DP system.

1-2. (canceled)

3. Simulator method for training a pilot of a vessel in the use of so-called dynamic positioning, wherein a distance signal indicating the distance between the vessel and a target is transmitted to a control system, whose function is to monitor the position of the vessel relative to the target, said method comprising the steps of:
a) providing a measurement system that outputs a first distance signal, said first distance signal corresponding to a measured first distance between said vessel and said target;
b) providing a control system that receives a display-distance signal and monitors a displayed distance between said vessel and said target, said displayed distance corresponding to said display-distance signal;
c) providing a signal switching means for optionally switching a signal transmission path;
d) providing a signal processing means for changing a value of said first distance signal to a second distance signal; and
e) providing a display means for displaying said displayed-distance signal.

4. The simulator method of claim 3, further comprising the steps of:
f) feeding said first distance signal as said display-distance signal to said control system; and
g) displaying an actually measured distance between said vessel and targe on said display means.

5. The simulator method of claim 3, further comprising the steps of:
h) switching said signal transmission path to feed said first distance signal through said signal processing means;
i) converting said first distance signal in said signal processing means to a second distance signal that corresponds to a simulated distance between said vesssel and said target;
j) feeding said second distance signal as said display-distance signal to said control system.

6. The simulator method of claim 5, wherein in said step i) said second distance signal is a signal that corresponds to a distance significantly smaller than said measured first distance,
k) displaying said simulated distance and said display means; and
l) monitoring said simulated distance between said vessel and said target.

7. A simulator system for training a pilot of a vessel in the use of so-called dynamic positioning, in which a measuring system produces a distance signal indicating a measured distance between the vessel and a target, and wherein a control system, which receives said distance signal, is arranged to activate the propulsion machinery and control mechanisms of the vessel in order to keep said vessel in a particular position relative to said target, said simulator system comprising:
said measuring system for transmitting said distance signal;
a display means for displaying a display-distance signal;
a control system adapted for monitoring a display-distance between said vessel and said target;
a signal conversion means for changing said distance signal to a simulated distance signal; and
a switching means for optionally switching a signal transmission path of said distance signal from a first path between said measuring system and said control system to a diversion path that feeds said distance signal to said signal conversion means;
wherein said distance signal is convertible to said simulated distance signal, which is then fed to said control system as said display-distance signal, and said display-distance signal is displayed on said display means; and
wherein said control system monitors distance between said vessel and said targe, based on said display-distance signal.

8. The simulator system of claim 7, wherein said signal conversion means includes a signal transducer for converting said distance signal to said simulated-distance value.

9. The simulator system of claim 8, wherein said simulated-distance signal corresponds to a simulated distance between said vessel and said target that is significantly smaller than said measured distance.

10. The simulator system of claim 7 further comprising additional sensors, wherein signals from said additional sensors are fed to said control system.
